(19) United States
(12) Patent Application Publication
(10) Pub. No.: US 2009/0176009 A1
(43) Pub. Date: Jul. 9, 2009

(54) COLORING STRUCTURE MANUFACTURING APPARATUS AND METHOD FOR MANUFACTURING COLORING STRUCTURE

(75) Inventors: Toshimitsu HIRAI, Hokuto (JP); Yasushi TAKANO, Matsumoto (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/344,620

(22) Filed: Dec. 29, 2008

(30) Foreign Application Priority Data
Jan. 8, 2008 (JP) 2008-001456

(51) Int. Cl. B05C 9/06; B05D 5/06; B05C 11/00

(52) U.S. Cl. 427/8; 118/712; 118/665

(57) ABSTRACT

A coloring structure manufacturing apparatus for manufacturing a coloring structure having a prescribed coloring characteristic, includes a film forming device which forms a transparent thin film with a thickness determined according to the coloring characteristic by coating a substrate with a liquid material, and a reflectance measuring device which measures a reflectance by irradiating the transparent thin film with detection light. The transparent thin film is formed such that two or more kinds of liquid materials having different refraction indexes are alternately applied to be laminated.

### BACKGROUND

1. Technical Field

The present invention relates to a coloring structure manufacturing apparatus and a method for manufacturing a coloring structure.

2. Related Art

Effort is put for improving texture of a coated face by using not only metallic coating with glittering materials of aluminum flakes heretofore employed, but also mica pieces or processed mica pieces as glittering materials along with upgrading of decorative members (for example, a clock face, a bracelet, a brooch, a housing of a mobile phone, and the like), or members of a vehicle (an interior dashboard, and the like). In the above technique, however, a color tone is influenced by a glittering material, but mainly influenced by a pigment or a dye so that still it is hard to prevent the color fading.

A technique of a coloring structure achieved by paying attention to a feather of a Morpho butterfly is disclosed in Japanese Patent No. 3443656 which is an example of related art. In the technique, a strip-like photocatalyst material thin film layer formed of TiO₂ or the like and a strip-like support material thin film layer formed of Si0₂ or the like which is thinner than the photocatalyst material thin film layer, are laminated to form a multi-layer structure. A photochromic member has arranged therein the plurality of multi-layer structures and is formed such that after a multi-layer thin film is formed by sputtering or the like, a prescribed amount of support material is removed by dry-etching or wet-etching to form an air gap.

Thus, in the above technique, the multi-layer film structure having the air gap is formed so that a surface area to be in contact with a photocatalyst can be enlarged, thereby a high photocatalyst effect can be expected. Specifically, it is possible to achieve a brilliant color having metallic luster by virtue of an optical interference effect obtained by making an optical layer thickness between the photocatalyst layer and the air gap layer to be one-fourth of a wavelength of coloring light, and by virtue of a diffraction grating effect obtained by the arranged structures.

However, the technique heretofore employed has following problems. The spattering used for forming the multi-layer thin film or the etching used for forming the support material thin film layer requires some number of processes and a large facility such as an exposure machine, resulting in lowering of the productivity. A multi-layer structure utilizing diffraction or interference of light, requires precise controlling of a film thickness in order to obtain a desired coloring characteristic. However, it is hard to precisely control the film thickness by each layer.

### SUMMARY

An advantage of the present invention is to provide a coloring structure manufacturing apparatus capable of efficiently and precisely manufacturing a coloring structure, and a method for manufacturing the coloring structure.

A coloring structure manufacturing apparatus for manufacturing a coloring structure having a prescribed coloring characteristic according to a first aspect of the invention includes a film forming device which forms a transparent thin film with a thickness determined according to the coloring characteristic by coating a substrate with a liquid material, and a reflectance measuring device which measures a reflectance by irradiating the transparent thin film with detection light. The transparent thin film is formed such that two or more kinds of liquid materials having different refraction indexes are alternately applied to be laminated.

Accordingly, in the coloring structure manufacturing apparatus, the coloring structure can be formed by using a simple method in which a film is formed by each of the two or more kinds of liquid materials having different refraction indexes so as to make the film with a thickness determined according to each coloring characteristic of the respective liquid materials, thereby it is possible to obviate the need of a large facility such as an exposure machine and to carry out efficient manufacturing.

As to the coloring characteristic, a reflection wavelength λ is expressed by a formula: λ=2×(n1×t1×cos θ1+n2×t2×cos θ2) in which refraction indexes of a first liquid material (a first transparent thin film) and a second liquid material (a second transparent thin film) are respectively represented by n1 and n2, thicknesses of the first transparent thin film and the second transparent thin film are respectively represented by t1 and t2, and refraction angles of the first transparent thin film and the second transparent thin film are respectively represented by θ1 and θ2. A reflectance (reflection intensity) R is expressed by a formula: R=(n1²−n2²)/(n1²+n2²). In addition, the coloring intensity exhibits the maximum when the optical thickness satisfies a formula: n1×t1=n2×t2=λ/4.

Accordingly, in a case where the refraction indexes n1 and n2, and the refraction angles θ1 and θ2 are preset depending on materials to be used in the invention, the thicknesses t1 and t2 of the first and second transparent thin films are adequately set based on the above formulas, thereby it is possible to develop a color with a desired wavelength in high coloring intensity.

In addition, as the reflectance is measured by irradiating the laminated transparent thin film with the detection light, thickness information of the formed transparent thin film can be obtained according to the reflectance, and then the thickness of the transparent thin film can be precisely adjusted based on the thickness information so as to allow the coloring structure to develop a desired color.

In the coloring structure manufacturing apparatus according to the invention, the reflectance measuring device may be preferably configured of a light projector which projects the detection light, a light receiver which receives reflection light reflected by the transparent thin film, and a controller which adjusts the thickness of the transparent thin film at the uppermost layer by controlling the film forming device on the basis of a received result of the light receiver.

Accordingly, as a desired color is developed based on the received reflection light in the invention, in a case where the thickness of the transparent thin film at the uppermost layer is measured to be small, the liquid material can be additionally applied so as to make the thickness of the transparent thin film at the uppermost layer to be a prescribed level (the thickness allowing a desired color to be developed).

In the coloring structure manufacturing apparatus according to the invention, the controller may preferably include a memory for storing a relationship between the reflectance and the thickness of the transparent thin film.

Accordingly, by collating the measured reflectance with the thickness of the transparent thin film stored beforehand in the invention, the thickness of the transparent thin film already formed can be readily obtained.

In the coloring structure manufacturing apparatus according to the invention, the controller may preferably allow the film forming device to apply the liquid material which is selected from the liquid materials having different concentrations prepared by each of the two or more kinds of liquid materials on the basis of the received result of the light receiver.

Accordingly, the liquid material having the concentration optimum for the thickness to be adjusted can be selected in the event of adjusting the thickness of the transparent thin film at the uppermost layer, thereby it is possible to adjust the thickness in the shortest period of time for coating.

In the coloring structure manufacturing apparatus according to the invention, the film forming device may preferably apply each of the two or more kinds of liquid materials by a droplet discharge method.

Accordingly, a necessary minimum amount of the liquid material can be efficiently applied to only a necessary region so that it is possible to improve the productivity.

The coloring structure manufacturing apparatus according to the invention, may preferably include a plasma processing device which imparts lyophilicity to the transparent thin film by applying plasma treatment to the transparent thin film, the lyophilicity being with respect to the liquid material to be applied on the transparent thin film.

Accordingly, in the event of applying the liquid material to the previously formed transparent thin film, the liquid material can spread to wet the transparent thin film so that the transparent thin film with the prescribed thickness can be uniformly formed.

A method for manufacturing a coloring structure having a prescribed coloring characteristic in a second aspect of the invention, includes (a) forming a transparent thin film with a thickness determined according to the coloring characteristic by applying a liquid material to a substrate, (b) laminating the transparent thin films by alternately applying two or more kinds of liquid materials having different refraction indexes to the substrate, and (c) measuring a reflectance by irradiating the laminated transparent thin film with detection light.

Accordingly, in the coloring structure manufacturing apparatus, the coloring structure can be formed by using a simple method in which a film is formed by two or more kinds of liquid materials having different refraction indexes so as to make the film with a thickness determined according to each coloring characteristic of the respective liquid materials, thereby it is possible to obviate the need of a large facility such as an exposure machine and to carry out efficient manufacturing.

As to the coloring characteristic, a reflection wavelength λ is expressed by the following formula: λ=2×(n1×t1×cos θ1+n2×t2×cos θ2) in which refraction indexes of a first liquid material (a first transparent thin film) and a second liquid material (a second transparent thin film) are respectively represented by n1 and n2, thicknesses of the first transparent thin film and the second transparent thin film are respectively represented by t1 and t2, and refraction angles of the first transparent thin film and the second transparent thin film are respectively represented by θ1 and θ2. A reflectance (reflection intensity) R is expressed by the formula: R=(n1²−n2²)/(n1²+n2²). In addition, the coloring intensity exhibits the maximum when the optical thickness satisfies the formula: n1×t1=n2×t2=λ/4.

Accordingly, in a case where the refraction indexes n1 and n2, and the refraction angles θ1 and θ2 are preset depending on the materials to be used in the invention, the thicknesses t1 and t2 of the first and second transparent thin films are adequately set based on the above formulas, thereby it is possible to develop a color with a desired wavelength in high coloring intensity.

In addition, as the reflectance is measured by irradiating the laminated transparent thin film with the detection light, thickness information of the formed transparent thin film can be obtained according to the reflectance, and then the thickness of the transparent thin film can be precisely adjusted based on the thickness information so as to allow the coloring structure to develop a desired color.

The method for manufacturing a coloring structure according the invention, further may preferably include (d) adjusting a thickness of the transparent thin film at an uppermost layer on the basis of the measured reflectance.

Accordingly, as a desired color is developed based on the received reflection light in the invention, in a case where the thickness of the transparent thin film at the uppermost layer is measured to be small, the liquid material is additionally applied so as to make the thickness of the transparent thin film at the uppermost layer to be a prescribed level (the thickness allowing a desired color to be developed).

The method for manufacturing a coloring structure according to the invention, further may preferably include (e) adjusting the thickness of the transparent thin film at the uppermost layer based on a relationship between the reflectance and the thickness of the transparent thin film.

Accordingly, by collating the measured reflectance with the thickness of the transparent thin film stored beforehand in the invention, the thickness of the already formed transparent thin film can be readily obtained.

The method for manufacturing a coloring structure according to the invention, may preferably include (f) applying the liquid material which is selected from the liquid materials having different concentrations prepared by each of the two or more kinds of liquid materials on the basis of the measured reflectance.

Accordingly, the liquid material having the concentration optimum for the thickness to be adjusted can be selected in the event of adjusting the thickness of the transparent thin film at the uppermost layer, thereby it is possible to adjust the thickness in the shortest period of time for coating.

In the method for manufacturing a coloring structure according to the invention, each of the two or more kinds of liquid materials may be preferably applied by using a droplet discharge method.

Accordingly, a necessary minimum amount of the liquid material can be efficiently applied to only a necessary region so that it is possible to improve the productivity.

The method for manufacturing a coloring structure according to the invention, may preferably include (g) applying plasma treatment to the formed transparent thin film to impart lyophilicity to the transparent thin film, the lyophilicity being with respect to the liquid material to be applied on the transparent thin film.

Accordingly, in the event of applying the liquid material to the previously formed transparent thin film, the liquid material can spread to wet the transparent thin film so that the transparent thin film with the prescribed thickness can be uniformly formed.

### BRIEF DESCRIPTION OF THE DRAWINGS

FIG. 1 is a schematic view illustrating a structure of a droplet discharge device.

FIG. 2A is a perspective view illustrating a droplet discharge head 301.

FIG. 2B is a sectional view illustrating a droplet discharge head 301.

FIG. 3 is a detail view illustrating a main part of a reflectance measuring device.

FIG. 4 is a sectional view illustrating a coloring structure C having a multi-layer structure formed on a substrate P.

FIG. 5 is a flow chart describing a method for manufacturing the coloring structure C.

FIGS. 6A through 6C are graphs illustrating a relationship between a wavelength of reflection light and a reflectance of a coloring structure C according to an embodiment of the invention.

FIG. 7A is a table showing a refraction index and a film thickness of each layer of a coloring structure C according to another embodiment of the invention.

FIG. 7B is a graph illustrating a relationship between a wavelength of reflection light and a reflectance of a coloring structure C having layers shown in FIG. 7A.

FIG. 8A is a table showing a refraction index and a film thickness of each layer of a coloring structure C according to another embodiment of the invention.

FIG. 8B is a graph illustrating a relationship between a wavelength of reflection light and a reflectance of a coloring structure C having layers shown in FIG. 8A.

FIG. 9A is a table showing a refraction index and a film thickness of each layer of a coloring structure C according to another embodiment of the invention.

FIG. 9B is a graph illustrating a relationship between a wavelength of reflection light and a reflectance of a coloring structure C having layers shown in FIG. 9A.

FIG. 10A is a table showing a refraction index and a film thickness of each layer of a coloring structure C according to another embodiment of the invention.

FIG. 10B is a graph illustrating a relationship between a wavelength of reflection light and a reflectance of a coloring structure C having layers shown in FIG. 10A.

FIG. 11A is a table showing a refraction index and a film thickness of each layer of a coloring structure C according to another embodiment of the invention.

FIG. 11B is a graph illustrating a relationship between a wavelength of reflection light and a reflectance of a coloring structure C having layers shown in FIG. 11A.

FIG. 12A is a table showing a refraction index and a film thickness of each layer of a coloring structure C according to another embodiment of the invention.

FIG. 12B is a graph illustrating a relationship between a wavelength of reflection light and a reflectance of a coloring structure C having layers shown in FIG. 12A.

FIG. 13A is a table showing a refraction index and a film thickness of each layer of a coloring structure C according to another embodiment of the invention.

FIG. 13B is a graph illustrating a relationship between a wavelength of reflection light and a reflectance of a coloring structure C having layers shown in FIG. 13A.

FIG. 14A is a table showing a refraction index and a film thickness of each layer of a coloring structure C according to another embodiment of the invention.

FIG. 14B is a graph illustrating a relationship between a wavelength of reflection light and a reflectance of a coloring structure C having layers shown in FIG. 14A.

FIG. 15A is a table showing a refraction index and a film thickness of each layer of a coloring structure C according to another embodiment of the invention.

FIG. 15B is a graph illustrating a relationship between a wavelength of reflection light and a reflectance of a coloring structure C having layers shown in FIG. 15A.

### DESCRIPTION OF EXEMPLARY EMBODIMENTS

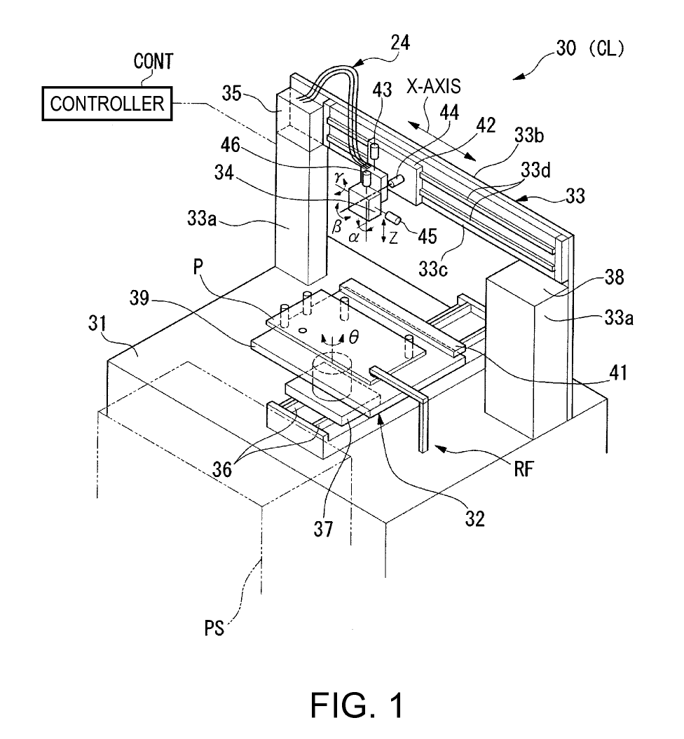

Embodiments of a coloring structure manufacturing apparatus and a method for manufacturing the coloring structure of the invention will be explained with reference to the accompanying drawings of FIGS. 1 through 15.

It should be noted that different scales are used for the members in the drawings, so that the members can be recognized.

Coloring structure manufacturing apparatus

First, the coloring structure manufacturing apparatus is described. In this embodiment, a case where a droplet discharge device for performing the coating and film-forming by discharging droplets of the liquid material is used as a film forming device for forming a transparent thin film by coating a substrate with a liquid material, is described below.

FIG. 1 is a schematic view illustrating an embodiment of the coloring structure manufacturing apparatus of this invention. In FIG. 1, the coloring structure manufacturing apparatus CL is mainly configured of a droplet discharge device (film forming device) 30, a reflectance measuring device RF, and a plasma processing device PS. The liquid discharge device 30 is configured of a base 31, a substrate moving unit 32, a head moving unit 33, a discharge head 34, a liquid tank 35, and a controller (control section) CONT.

The substrate moving unit 32 and the head moving unit 33 are mounted on the base 31. The substrate moving unit 32 is provided on the base 31 and has a guide rail 36 placed along a Y-axis direction. The substrate moving unit 32 is so constituted that a slider 37 is moved along the guide rail 36 by, for example, a linear motor. The slider 37 is equipped with a θ-axis motor (not shown). The above motor is, for example, a direct drive motor and a rotor thereof (not shown) is fixed to a table 39. In the above structure, when the motor is energized, the rotor and the table 39 are rotated in the θ-direction, the table 39 is indexed (the rotational indexing is carried out).

The table 39 determines the position of the substrate P and holds it. The table 39 has a well-known attraction holding unit (not shown), and the substrate P is attracted to be held on the table 39 by driving the attraction/holding unit. The substrate P is accurately positioned to be held on the table 39 at a prescribed position by means of a positioning pin (not shown). An abandoning area 41 for allowing the discharge head 34 to discharge ink (liquid) for testing or abandoning (flushing area) is provided to the table 39. The abandoning area 41 is extended in the X-axis direction to be provided to the rear side of the table 39.

The head moving unit 33 is configured of a pair of pedestals 33a, 33a and a running path 33b suspended on the pedestals 33a, 33a which is disposed in the X-axis direction, i.e., a direction perpendicular to the Y-axis direction of the substrate moving unit 32. The running path 33b is configured of a hold plate 33c suspended to the pedestals 33a, 33a and a pair of guide rails 33d, 33d provided on the hold plate 33c. The running path 33b movably holds a slider 42 for carrying the discharge head 34 in the elongated direction of the guide rails 33d, 33d. The slider 42 runs on the guide rails 33d, 33d by the action of a linear motor or the like (not shown). By the movement of the slider 42, the discharge head 34 can be moved in the X-axis direction.

Motors 43, 44, 45, and 46 as swinging position determining units are coupled to the discharge head 34. By operating the motor 43, the discharge head 34 can be vertically moved along a Z-axis to be positioned on the Z-axis. The direction of the Z-axis is perpendicular to the X-axis and the Y-axis, respectively (vertical direction). When the motor 44 is operated, the discharge head 34 is swung along a β-direction in FIG. 1 to be positioned. When the motor 45 is operated, the discharge motor 34 is swung in a γ-direction to be position. When the motor 46 is operated, the discharge head 34 is swung in an α-direction to be positioned.

Thus, the discharge head 34 can be straightly moved on the slider 42 in the Z-axis to be positioned, and is swung in the α, β and γ-directions to be positioned. Accordingly, the position and attitude of the ink discharge face of the discharge head 34 with respect to the substrate P at the side of the table 39 can be accurately controlled.

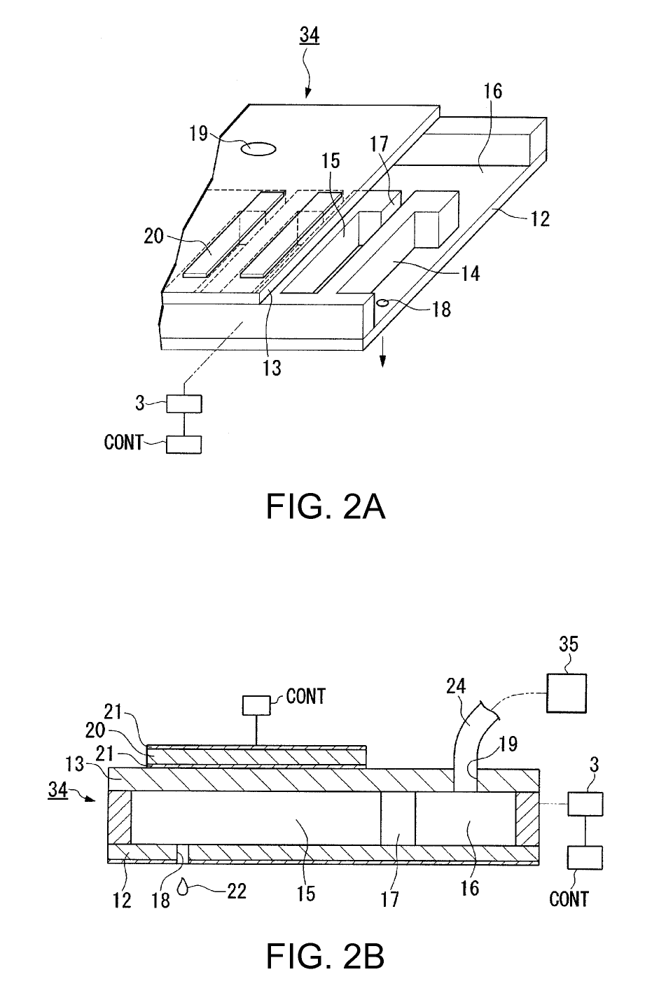

FIG. 2A and FIG. 2B are schematic structural views illustrating the discharge head 34. As shown in FIG. 2A, the discharge head 34 is equipped with, for example, a nozzle plate 12 made of stainless and a vibrating plate 13, both of them being bonded to each other with a partition member (reservoir plate) 14 therebetween. A plurality of cavities 15 and a reservoir 16 are formed at a portion between the nozzle plate 12 and the vibrating plate 13, and the cavities 15 and the reservoir 16 are coupled with fluid channels 17. The discharge head 34 is provided with a heater (heating unit) 3 of which the power is controlled by the controller CONT.

Each of the inner sections of the cavities 15 and the reservoir 16 is filled with the liquid and the fluid channels 17 function as supply holes for supplying the liquid to the cavities 15. A plurality of nozzles 18 for discharging the liquid are formed on the nozzle plate 12 such that the nozzle are arranged in the lateral and longitudinal directions. A hole 19 opened in the reservoir 16 is formed on the vibrating plate 13 and a liquid tank 35 is coupled to the hole 19 with a tube 24 (see FIG. 1).

A piezoelectric element (piezo element) 20 is bonded to the vibrating plate 13 at the face opposite the face facing the cavity 15, as shown in FIG. 2B. The piezoelectric element 20 is nipped with a pair of electrodes 21, 21 and is projected to be bent to the outside by energizing the electrodes 21, 21, thereby functioning as a discharging unit.

The vibrating plate 13 having bonded thereto the piezoelectric element 20 is bent to the outside together with the piezoelectric element 20, and then the volume of the cavity 15 is increased. As the cavity 15 and the reservoir 16 are coupled, when the reservoir 16 is filled with the liquid, the liquid in the cavity 15 in an amount equal to the increased volume of the cavity 15 flows into the cavity 15 from the reservoir 16 through the fluid channel 17. At that time, liquid with an amount equal to that of the flow-in liquid is supplied to the reservoir 16 from the liquid tank 35 through the tube 24.

In the above condition, when the energizing of the piezoelectric element 20 is stopped, the piezoelectric element 20 and the vibrating plate 13 are restored to be in the original shapes. Also, the cavity 15 is restored to be in the original volume, so that the pressure of the liquid in the cavity 15 is raised, thereby a droplet 22 of the liquid is discharged from the nozzle 18.

In this embodiment, two or more kinds of liquids (actually two kinds of liquids, specifically total four kinds of liquids because each kind of the liquid includes a high concentration liquid and a low concentration liquid, details are described later) are stored in the liquid tank 35. Each liquid is supplied to the respective reservoir 16 through the tube 24 coupled to the tank 15 to be injected to the cavity 15, and then the liquid is discharged from the nozzle 18 as a droplet corresponding to each liquid. The discharging of the liquid in the prescribed kind by selectively driving the piezoelectric elements 20 is controlled by the controller CONT.

As the discharge unit of the discharge head, not only an electromechanical transducer using the piezoelectric element (piezo element) 20, but also other methods, for example, a method using an electrothermal transducer as an energy generation element, a continuous method such as a charge control type, and a pressure-vibration type, and further a method of discharging liquid by action of heat generated by irradiation of an electromagnetic wave such as laser light, can be utilized.

By returning to FIG. 1, the other constitution of the liquid discharge device 30 is described below. The controller CONT controls the liquid discharge operation of the discharge head 34, the operation of driving the substrate moving unit 32 and the head moving unit 33, and the supplying of power to the heater 3.

The above described liquid tank 35 is disposed on one of the pedestals 33a, 33a and the heater (not shown) is provided to the inner or outer side of the liquid tank 35. The heater is adapted to heat the reserved liquid. Particularly, when the liquid has high viscosity, the viscosity is lowered by the heating so that it is possible to facilitate the flowing of the liquid to the discharge head 34 from the liquid tank 35.

As the pedestals 33a, 33a are adapted to support the running path 33b, they are positioned to be sufficiently near the discharge head 34 running on the running path 33b. The length of the tube 24 for conveying the liquid to the discharge head 34 from the liquid tank 35 is sufficiently shorter than heretofore to be roughly equal to the length of the running path 33b.

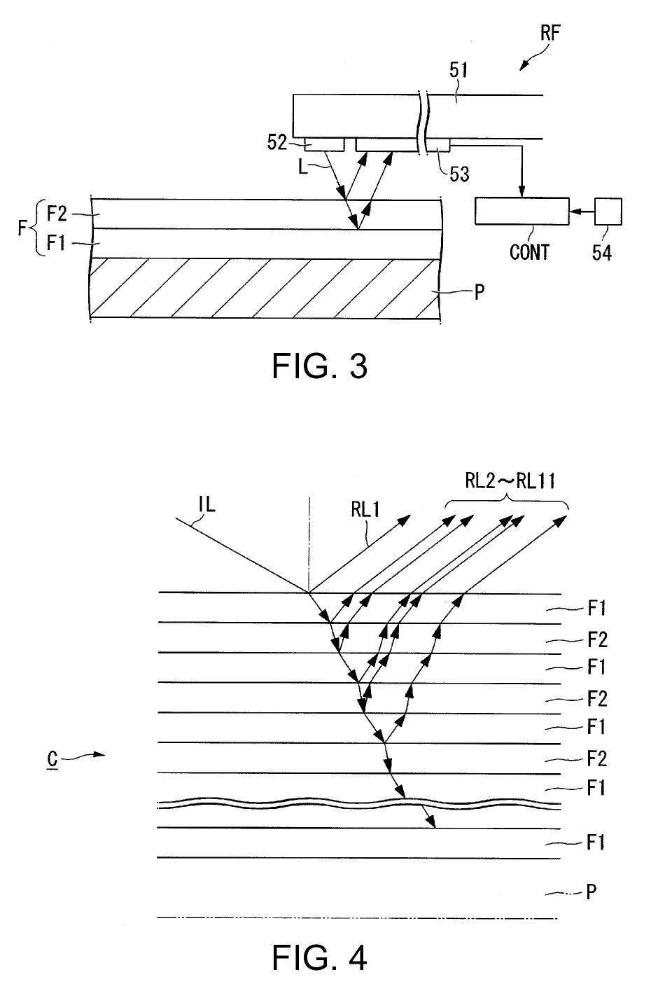

The reflectance measuring device RF is formed in an L-shaped and is disposed on the base 31 at the opposite side of the discharge head 34 in the vicinity of the guide rail 36. As shown in FIG. 3, an extension part 51 extended to a position facing the surface of the substrate P above the substrate P is provided to the tip portion of the reflectance measuring device RF. A light projector 52 and a light receiver 53 are provided to the extension part 51 at a position opposite to the substrate P (i.e., transparent thin films F1, F2, to Fn formed on the substrate P (described later)).

The light projector 52 is adapted to project detection light L such as halogen light to the substrate P (transparent thin film F). The light receiver 53 is adapted to receive reflection light (interference light) which is interfered and reflected by the transparent thin film F to output the received result to the controller CONT and is configured of, for example, a spectroscopic sensor for measuring a light quantity by each wave length. A memory 54 is connected to the controller CONT. The relationship between the reflectance and the thickness of the film which is obtained by measurement or simulation beforehand is stored in the memory 54.

The controller CONT controls the kind and the amount of the liquid to be discharged from the liquid discharge device 30 on the basis of the received result of the light receiver 53 and the relationship between the reflectance and the thickness of the film stored in the memory 54.

The plasma processing device PS is provided to a portion on the moving path of the substrate P by the substrate moving unit 32 at the opposite side of the head moving unit 33, and is adapted to irradiate the surface of the substrate P or the surface of the transparent thin film F with oxygen in a plasma condition by using, for example, an atmospheric-pressure plasma process with respect to the transparent thin film F after the transparent thin film F is formed on the substrate P, thereby the surface is made to be lyophilic or activated.

As a result, wettability of the surface of the substrate P or the surface of the transparent thin film F is improved so that uniformity of the thickness of the transparent film formed on the above surface can be improved.

Next, a coloring structure formed on the substrate by using the coloring structure manufacturing apparatus CL is described with reference to FIG. 4. FIG. 4 is a sectional view of the coloring structure C which has a multi-layer structure and is formed on the substrate P.

The coloring structure C shown in FIG. 4 is so constituted that a first transparent thin film F1 and a second transparent thin film F2 having different refraction indexes are alternately formed in a plurality of layers by each of the first and second thin films. In this embodiment, each of the odd-numbered layers, such as the first, the third to the eleventh layers numbering from the substrate P is formed of the first transparent thin film F1, and each of the even-numbered layers, such as the second to tenth layers numbering therefrom is formed of the second transparent thin film, thereby the coloring structure C having eleven layers of thin films is formed.

In the embodiment, the coloring structure C is formed by using the thin film materials of the first transparent thin film F1 and the second transparent thin film F2 in which the refraction index (first refraction index) of the first transparent thin film F1 is smaller than that (second refraction index) of the second transparent thin film F2, and the thickness of the first transparent thin film F1 is greater than that of the second transparent thin film F2.

As the substrate P, a glass, an Si substrate, a plastic substrate, a metallic substrate and the like can be selectively used. As the forming materials of the first transparent thin film F1 and the second transparent thin film F2, a polysiloxane resin (refraction index: 1.42), SiO₂ (quartz; refraction index: 1.45), Al₂O₃ (aluminum; refraction index: 1.76), ZnO (zinc oxide; refraction index: 1.95), titanium oxide (refraction index: 2.52), Fe₂O₃ (ferric oxide; refraction index: 3.01) or the like can be selected.

In the coloring characteristic of the coloring structure C in the multi-layer structure, reflection light RL1 which is reflected light of incident light IL by the uppermost layer of the transparent thin film, is interfered with reflected light RL2 to RL11 which is obtained such that the incident light IL is refracted by the transparent thin films when entering and output from the next layer or layers lower than the next layer by being reflected thereby.

Based on a thin film interference theory, the interfered color (wavelength of the reflection light) and the intensity are expressed by the following formulas in which the refraction indexes of the first transparent thin film F1 and the transparent thin film F2 are respectively represented by n1 and n2, the thicknesses of the first transparent thin film F1 and the second transparent thin film F2 are respectively represented by t1 and t2, and the refraction angles of the first transparent thin film F1 and the second transparent thin film F2 are respectively represented by θ1 and θ2.

The reflection wavelength λ is expressed as follows.

λ=2×(n1×t1×cos θ1+n2×t2×cos θ2) (1)

The reflectance (reflection intensity) R is expressed as follows.

R=(n1²−n2²)/(n1²+n2²) (2)

As in the formula (1) representing the reflectance, it is revealed that as the difference between the refraction indexes of the first transparent thin film F1 and the second transparent thin film F2 becomes larger, the reflection intensity (coloring intensity) becomes greater.

The coloring intensity exhibits the maximum when the optical thickness satisfies the following formula.

n1×t1=n2×t2 =λ/4 (3)

When, for example, the materials of the first transparent thin film F1 and the second transparent thin film F2 are selected based on the reflection intensity, the refraction indexes n1 and n2, and the refraction angles θ1 and θ2 are determined. As a result, it is possible to set the thickness t1 or t2 of each of the layers of the first transparent thin film F1 and the second transparent thin film F2 and the number of laminated layers for obtaining desired reflectances by using a desired coloring characteristic (λ) and the formulas (1) to (3).

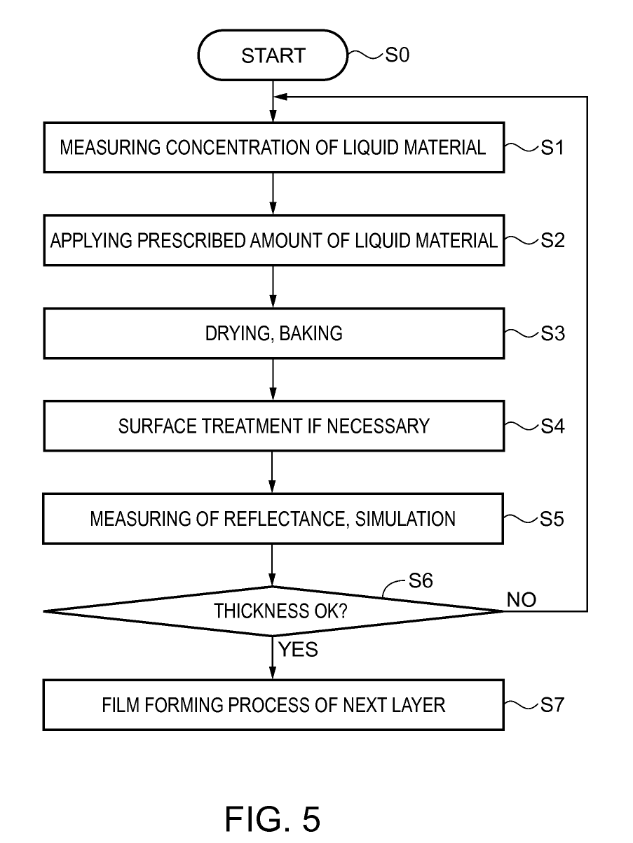

Next, a sequence of forming the coloring structure C on the substrate P by using the coloring structure manufacturing apparatus CL is explained according to a flow chart with reference to FIG. 5. Here, the first transparent thin film F1 is formed from a polysiloxane resin (siloxane polymer; refraction index: 1.42). As liquid materials including polysiloxane resins, two kinds of the liquid materials having concentrations of 3 wt % and 6 wt % are prepared.

The second transparent thin film F2 is formed from titanium oxide (refraction index: 2.52). As the liquid materials including titanium oxide, two kinds of the liquid materials having concentrations of 2 wt % and 4 wt % are prepared. Here, a case in which the second transparent thin film F2 is formed on the first layer of the first transparent thin film F1 formed on the substrate P beforehand is described below.

When a film forming process is started (step S0), the concentration of the liquid material to be used for forming the second transparent thin film F2 as the second layer is selected.

In order to make the thickness of the film of each layer to be smaller (not thicker) than the preset one, the liquid material including a second transparent thin film forming material (the liquid material including titanium oxide) having a low concentration (concentration=2 wt %) is selected (step S1). In a case where it is already known that even when a liquid material including a second transparent thin film forming material of a high concentration (concentration=4 wt %) is selected, the thickness is made to be lower (not thicker than) than the preset one, it is possible to select the high concentration material.

After the substrate P is coated with droplets of the second liquid material including the second transparent thin film forming material by using the droplet discharge device 30 described as in the step S2, drying treatment in one minute at temperature of 180° C. and baking treatment in three minutes at temperature of 200° C., for example, are carried out (step S3) to form the second transparent thin film F2 on the first transparent thin film F1.

Next, surface treatment for imparting lyophilicity to the surface of the second transparent thin film F2 is carried out on an as-needed basis (step S4). The surface treatment is adapted to improve wettability (lyophilicity) of the underlayer (second transparent thin film F2 in this case) with respect to a liquid material to be applied next. If the underlayer and the liquid material to be applied are the same, the surface treatment is not necessary because there is the lyophilicity. In a case where the thickness of the film measured later is equal to a prescribed level, the substrate P is moved to the plasma processing device PS by means of the substrate moving unit 32 in order to coat the second transparent thin film F2 with a liquid material different from the that of the second transparent thin film F2. The surface of the second transparent thin film F2 formed on the substrate P is subjected to the atmospheric-pressure plasma process, thereby improving the wettability (lyophilicity) with respect to the first liquid material.

Upon the completion of the surface treatment to the second transparent thin film F2, the substrate P (second transparent thin film F2) is moved to be positioned just below the light projector 52 by means of the substrate moving unit 32. The light projector 52 projects the detection light L toward the substrate P (second transparent thin film F2) to irradiate the substrate P with the detection light L, and the light receiver 53 receives the reflection light.

The controller CONT computes the reflectance based on the measurement result of the light receiver 53 to obtain the thickness of the second transparent thin film F2 by collating the reflectance with the relationship stored in the memory 54. The controller CONT judges whether or not the obtained thickness is equal to a prescribed thickness (step S6). When the controller determines that it is equal to the prescribed thickness, the process is advanced to the next step of the film forming process of the next layer (step 7).

When the controller CONT determines that the thickness of the second transparent thin film F2 is lower than the prescribed thickness in the step S6, the controller CONT performs again the processes of the step S1 and the succeeding steps in order to adjust the thickness of the second transparent thin film F2. At that time, in the step 1 carried out again, the liquid material is selected so as to form the second transparent thin film F2 of which the thickness is equal to a difference between that of the second transparent thin film F2 obtained in the step S5 and the prescribed thickness.

In a case where, for example, the second transparent thin film F2 is formed to be in the thickness roughly half of the prescribed thickness even through the second liquid material with high concentration is selected in the former film forming process, the second liquid material with high concentration is selected again. In a case where the second transparent thin film F2 is formed to be in the thickness more than half of the prescribed thickness, the second liquid material with low concentration is selected. In a case where the second liquid material with low concentration is selected in the former film forming process, the second liquid material with low concentration is selected again and the amount of the droplet is controlled. After that, the steps S1 to S5 are repeated until the thickness of the second transparent thin film F2 becomes the prescribed thickness.

When the second transparent thin film F2 is formed in the prescribed thickness, the above sequence is repeated, and then the first transparent thin film F1 and the second transparent thin film F2 are alternately laminated to form the coloring structure C as shown in FIG. 4.

### EXAMPLES

The first transparent thin film F1 and the second transparent thin film F2 were formed by using a first liquid material including siloxane polymer (refraction index: 1.42) as the first transparent thin film forming material, and a second liquid material including titanium oxide (refraction index: 2.52) as the second transparent thin film forming material.

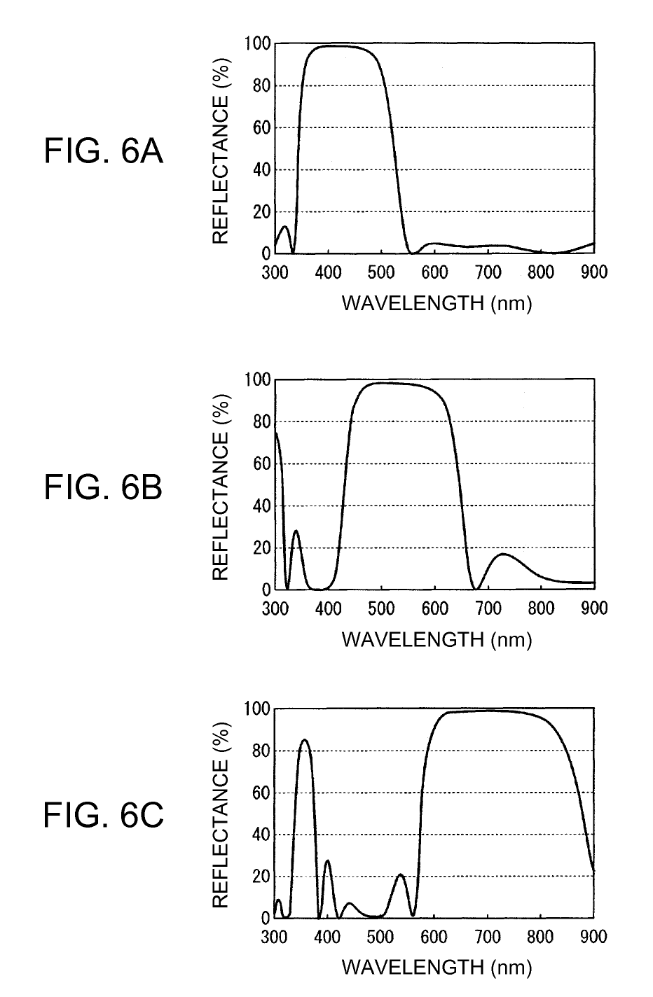

Here, in a case where, for example, a blue color (λ=480 nm) is to be developed, each first transparent thin film F1 was formed in the thickness of t1=84.5 nm and each second transparent thin film F2 was formed in the thickness of t2=47.6 nm according to the formula (3). As a result, as shown in FIG. 6A, the coloring characteristic of the blue color was exhibited in the reflectance of 80% or more.

Likewise, in a case where, for example, a green color (λ=520 nm) is to be developed, each first transparent thin film F1 was formed in the thickness of t1=91.5 nm and each second transparent thin film F2 was formed in the thickness of t2=52.0 nm according to the formula (3). As a result, as shown in FIG. 6B, the coloring characteristic of the green color was exhibited in the reflectance of 80% or more.

Further, in a case where, for example, a red color (λ=630 nm) is to be developed, each first transparent thin film F1 was formed in the thickness of t1=111.0 nm and each second transparent thin film F2 was formed in the thickness of t2=62.5 nm according to the formula (3). As a result, as shown in FIG. 6C, the coloring characteristic of the red color was exhibited in the reflectance of 80% or more.

Thus, in the embodiment, the coloring structure C having the desired coloring characteristic can be readily and efficiently manufactured such that the first transparent thin film F1 and the second transparent thin film F2 in the respective thicknesses according to the desired coloring characteristic are alternately formed to be laminated by using the droplet discharge method without requiring many processes nor requiring a large facility.

In the embodiment, by projecting the detection light L to the transparent thin film F and measuring the reflectance of the reflection light, the thickness of the transparent thin film can be readily detected and the thickness of the transparent thin film at the uppermost layer can be adjusted so that the thickness of the transparent thin film is precisely controlled to readily obtain the desired coloring characteristic.

In the embodiment, as the relationship between the reflectance and the film thickness is obtained beforehand to be stored, it is possible to immediately obtain the thickness of the transparent thin film during the film forming process, thereby improving the productivity.

In the embodiment, as the liquid material which is selected from the liquid materials having different concentrations by each of the two or more kinds of liquid materials, is used, the liquid material with the concentration optimum for the thickness to be adjusted is selected when the thickness of the transparent thin film at the uppermost layer is adjusted so that it is possible to adjust the thickness in the shortest period of time for coating, thereby the productivity can be improved.

In the embodiment, as the lyophilicity is imparted to the surface of the transparent thin film F by applying the plasma process thereto on an as needed basis, when the liquid material of the next layer is applied to the layer as the underlayer, the liquid material can adequately spread to wet the layer so that the transparent thin film F with the prescribed thickness can be uniformly formed.

In the embodiment, as the liquid material is applied by the liquid discharge method, a minimum necessary amount of the liquid material can be efficiently applied on a necessary region, thereby further improving the productivity.

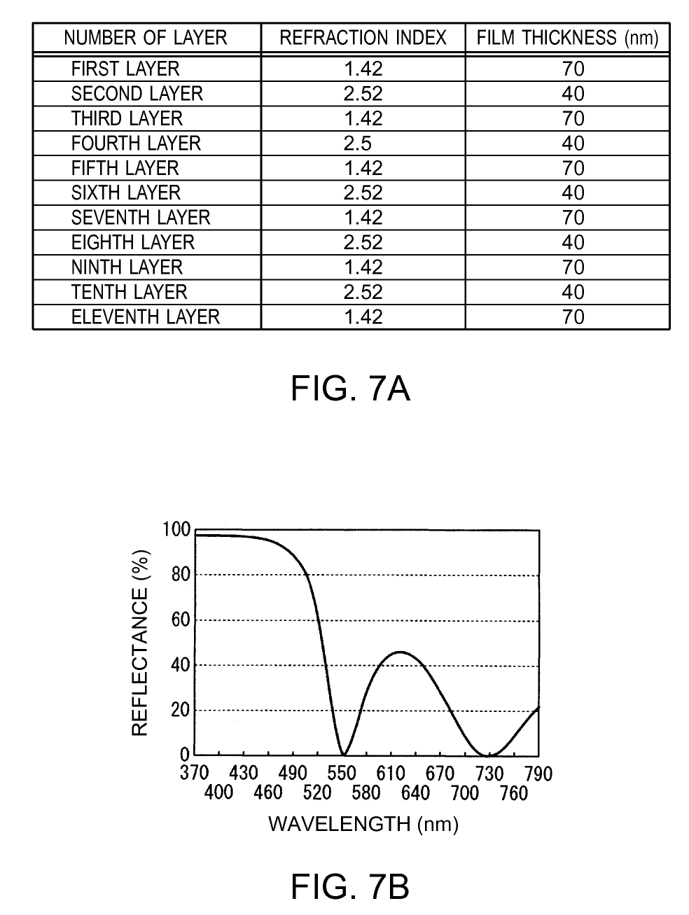

Next, another embodiment of the coloring structure C is described below with reference to FIG. 7 through FIG. 14. In the first embodiment, each of the first transparent thin film F1 and the second transparent thin film F2 is formed to be in the same thickness. However, in the second embodiment, the film thickness of each of the uppermost layer and the lowermost layer is made different from that of the other.

FIG. 7A shows the thicknesses of the first transparent thin film F1 and the second transparent thin film F2. The first transparent thin film F1 is formed at each of the odd-numbered layers by using the siloxane polymer (refraction index: 1.42) and the second transparent thin film F2 is formed at each of the even-numbered layers by using titanium oxide (refraction index: 2.52). Here, the thickness of the first transparent thin film F1 is made to be 70 nm and the thickness of the second transparent thin film F2 is made to be 40 nm in order to acquire a reflection spectrum of a blue color with the wavelength of approximately 430 to 450 nm. FIG. 7B shows a reflection characteristic indicated by a relationship between a wavelength of reflection light and a reflectance.

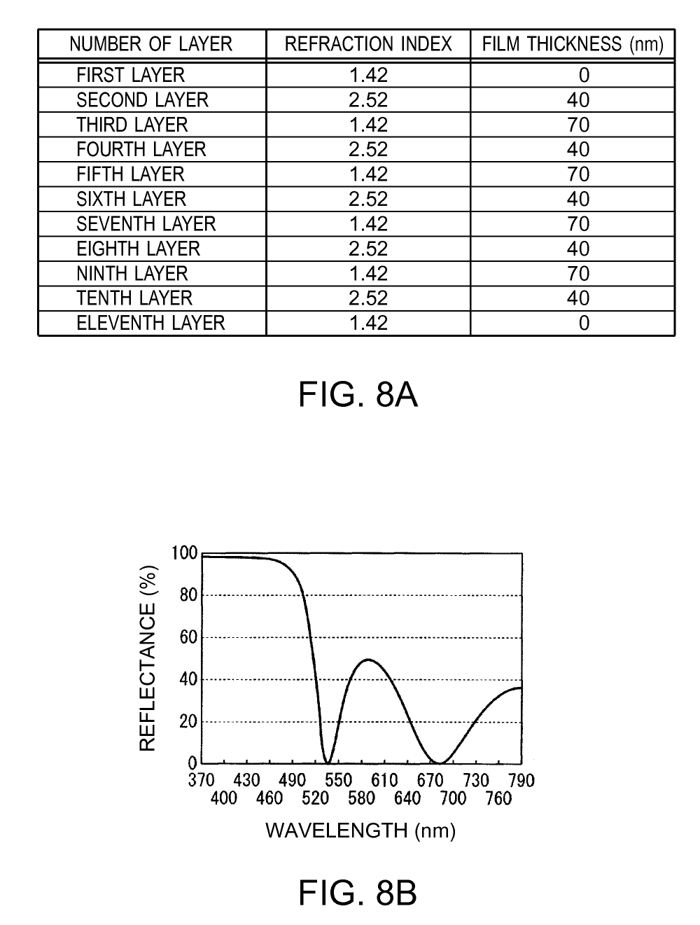

FIGS. 8A through 14A show thicknesses of the first transparent thin film F1 and the second transparent thin film F2. In FIGS. 8A through 14A, film thickness of each of the lowermost layer and the uppermost layer is varied to be 0 (i.e., thickness=zero), 0.5, 1.5, 2, 3, 4, and 5 times of the thickness of the first transparent thin film F1 or the second transparent thin film F2 indicated in FIG. 7A. Each of FIGS. 7B through 14B shows characteristics of the reflection light represented by the relationship between the wavelength of the reflection light and the reflectance of the respective coloring structure C constituted of the first transparent thin film F1 and the second transparent thin film F2 each having the thickness indicated in the FIGS. 7A through 14A.

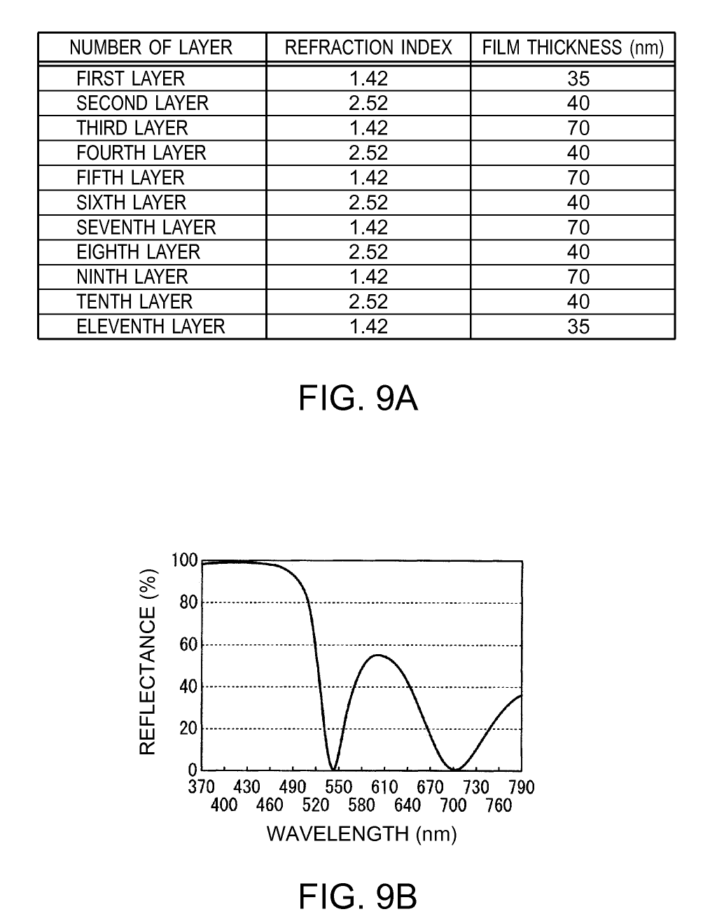

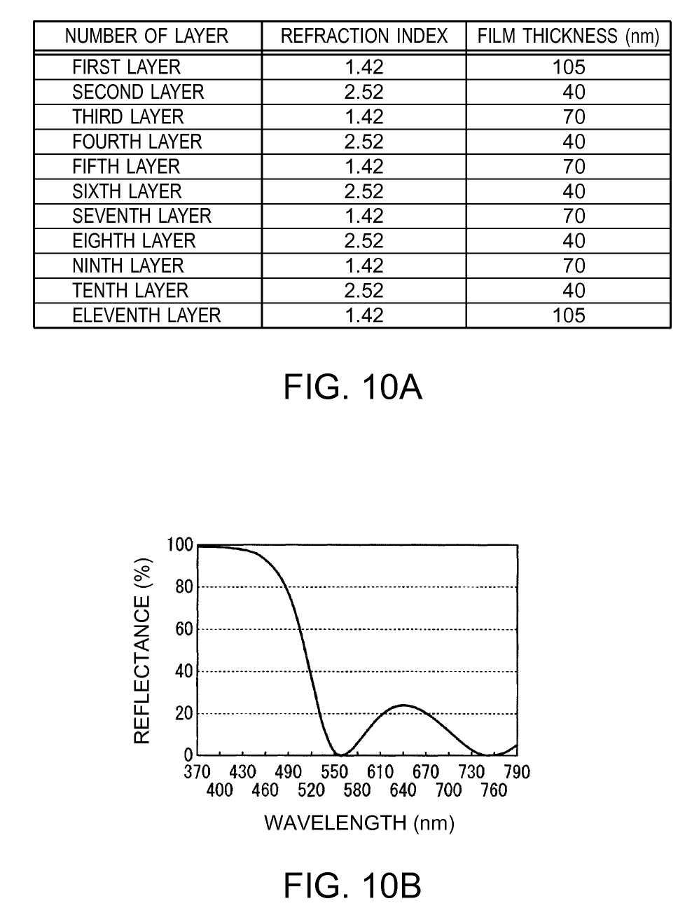

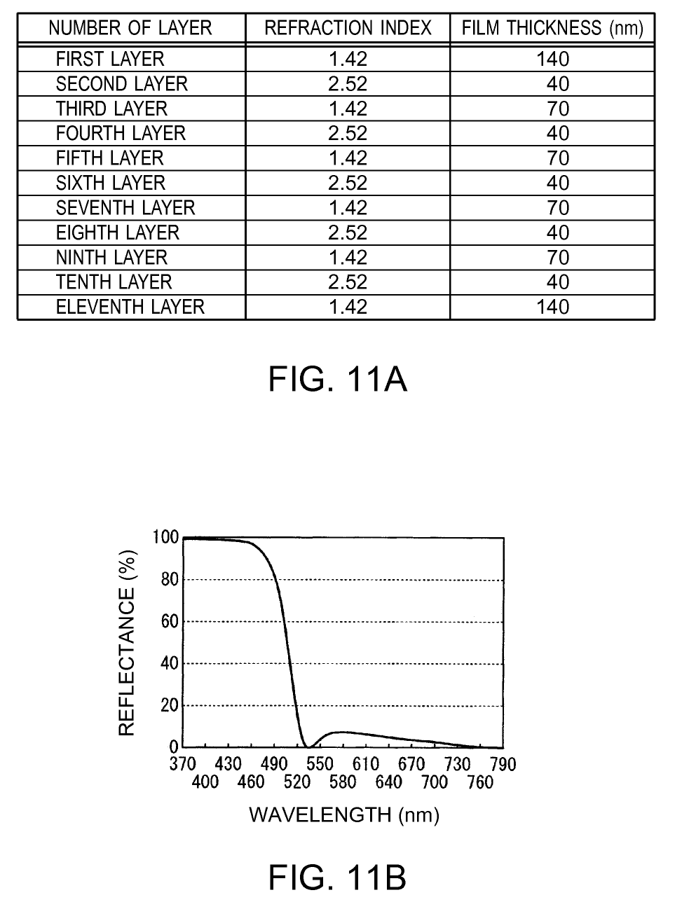

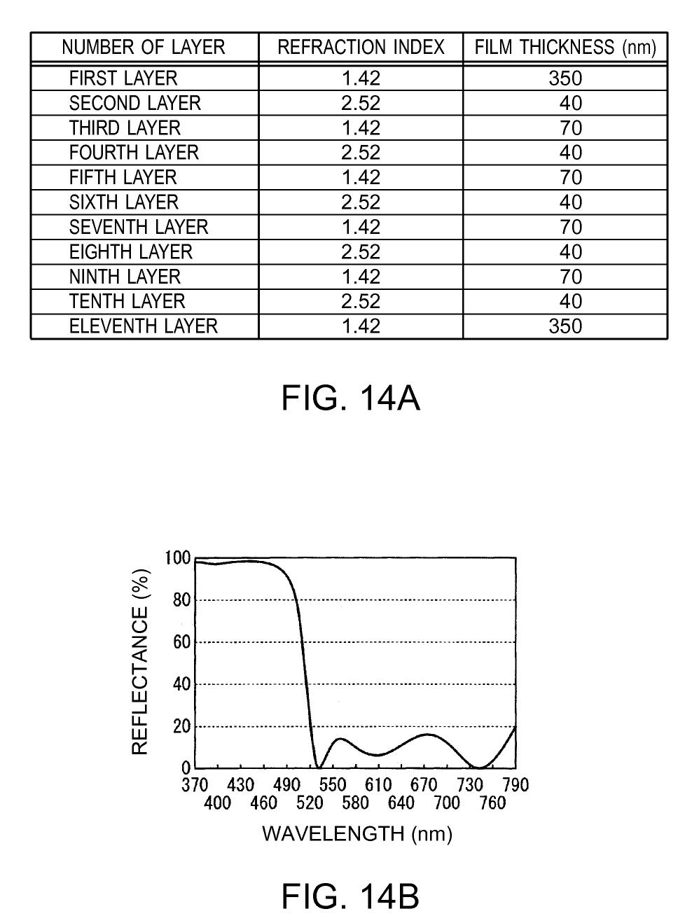

As indicated by the reflection characteristics in the FIG. 7B, FIG. 8B and FIG. 9B, when the film thickness of each of the uppermost layer and the lowermost layer is smaller than the film thickness of the other layer, each reflection peak of the wavelength region out of a prescribed region becomes large. As indicated by the reflection characteristics in the FIG. 10B, FIG. 11B and FIG. 14B, when the film thickness of each of the uppermost layer and the lowermost layer is 1.5, 2, or 5 times of the thickness of the other layer, each reflection peak of the wavelength region out of a prescribed region can be made small.

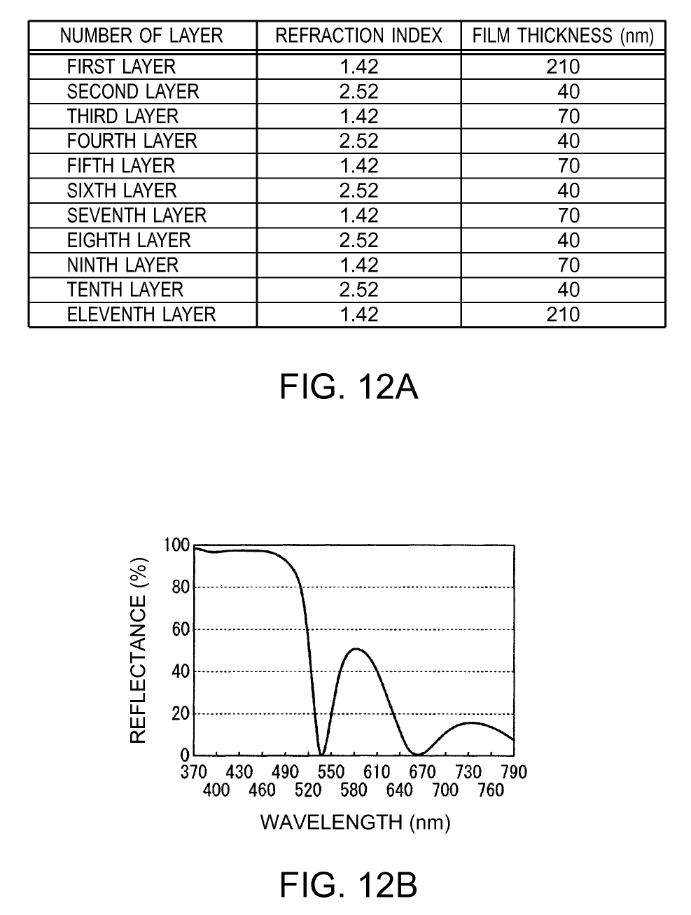

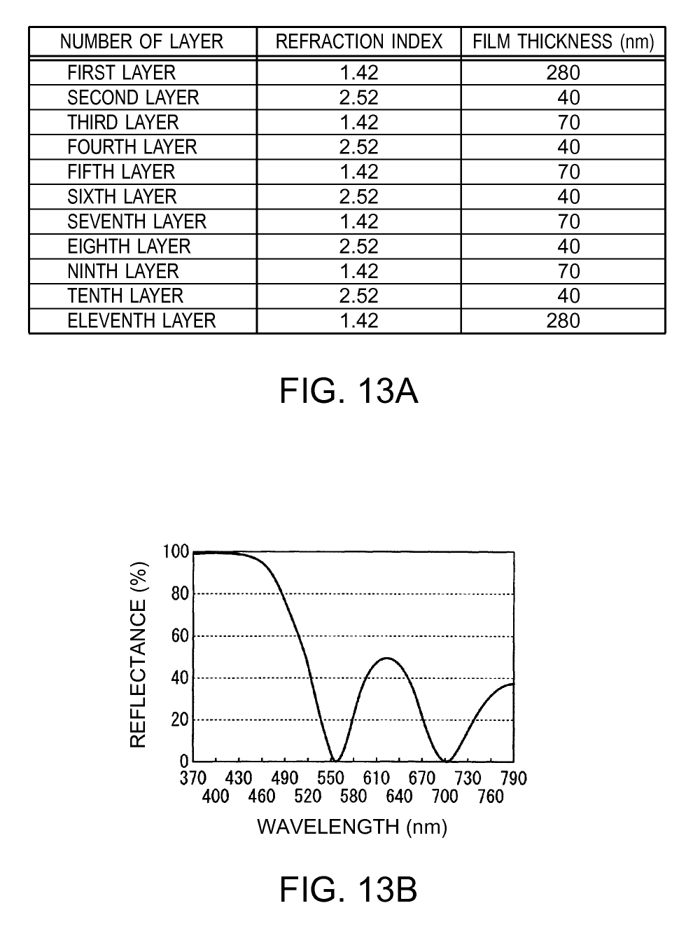

As indicated by the reflection characteristics in the FIG. 11B, FIG. 12B and FIG. 13B, when the film thickness of each of the uppermost layer and the lowermost layer is 2, 3, or 4 times of the film thickness of the other layer, the reflection peak of the wavelength region out of a prescribed region can be made small. In a case where the coloring structure C with the film thickness as described above is manufactured, it is possible to precisely control the film thickness and the coloring characteristic by using the above described measurement of the reflectance.

Accordingly, in this embodiment, it is possible to obtain the operation or the effect similar to that of the first embodiment, and also it is possible to obtain more excellent coloring characteristic by enlarging the film thickness of each of the uppermost and lowermost layers more than that of the other layer. In the embodiment, by making the film thickness of each of the uppermost and lowermost layers to be two times of the other layer, the reflection peak in the wavelength region out of the prescribed region can be reduced, thereby more excellent coloring characteristic can be obtained.

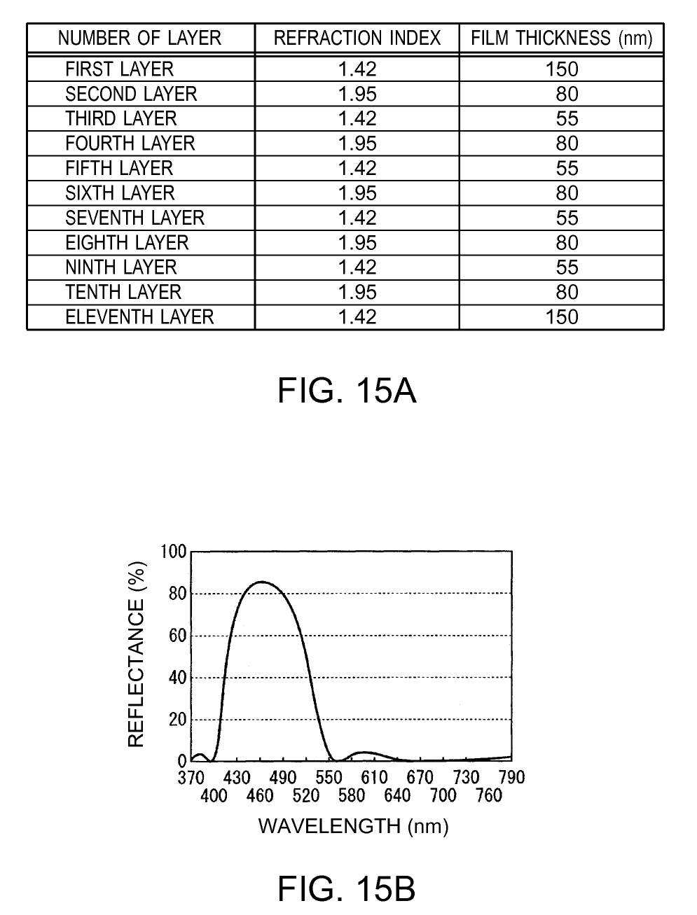

Further, another embodiment of the coloring structure C is described below with reference to FIG. 15. In the above embodiment, the first transparent thin film F1 and the second transparent thin film F2 are formed such that the thickness of the first transparent thin film F1 having the small refraction index is greater than the thickness of the second transparent thin film F2 having the large refraction index. However, this embodiment has a structure contrary to the above embodiment.

FIG. 15A shows the film thickness and the refraction index of each of layers of the first transparent thin film F1 and the second transparent thin film F2. The first transparent thin film F1 is formed at each of the odd-numbered layers by using the siloxane polymer (refraction index: 1.42) and the second transparent thin film F2 is formed at each of the even-numbered layers by using zinc oxide (refraction index: 1.95). FIG. 15B shows a reflection characteristic indicated by a relationship between a wavelength of reflection light and a reflectance of the coloring structure C formed by the above film thicknesses.

As shown in FIG. 16A, in the embodiment, except the film thicknesses of the uppermost and lowermost layers, the thickness of the first transparent thin film F1 having the small refraction index is made to be smaller than the thickness of the second transparent thin film F2 having the large refraction index. In the same way as the second embodiment, the film thickness of each of the uppermost and lowermost layers is made greater than that of the other layer.

In addition, as shown in FIG. 15B, in the embodiment, the reflection peak in the wavelength region out of the prescribed region can be reduced and the wavelength region of the reflection peak exhibiting out of the prescribed region can be reduced, thereby excellent coloring characteristic can be obtained.

The coloring structure C described in the above embodiments can be widely used in a decorative member (designing member, exterior member) such as, for example, a clock face, a bracelet, a brooch, a housing of a mobile phone, and the like. By using the coloring structure C and the method for manufacturing the same, it is possible to efficiently manufacture the decorative members (designing member, exterior member), to reduce the manufacturing cost, and to provide the decorative member (designing member, exterior member) superior in the productivity.

Thus, while the invention is explained by using the preferable embodiments with reference to the drawings, the invention is not limited to the above embodiments. Each of the shapes or combinations of each structural member indicated in the embodiments is an example, and can be modified according to the designing demand or the like within the scope of the invention.

For example, in the above embodiment, the first transparent thin films F1 are formed at the odd-numbered layer and the second transparent thin films F2 are formed at the even-numbered layer. However, the formation is not limited to the above, and then the inverted lamination arrangement can be taken. The number of laminated layers of the transparent thin films designated in the above embodiment, is an example so that the number of layers can be not greater than 11 or not lower than 11, if a desired reflection characteristic is obtained.

As the adjustment of the thickness of the transparent thin film in the above embodiment, in at least one of the first transparent thin film F1 and the second transparent thin film F2, a particle diameter of the first transparent thin film material or the second transparent thin film material can be used. In the above case, it is preferable to take a method for inputting a dispersion accelerator to the liquid material in order to prevent the particles included in the applied liquid material from being piled up.

In addition, in a case where the transparent thin film is formed in the thickness not smaller the diameter of the particle, the thickness of the transparent thin film is made to be an integer multiple of the diameter of the particle, and a process of forming a film by a thickness of the diameter of the particle is repeated tow or more times, thereby it is possible to precisely form the film by uniform thickness without variation.

While the liquid discharge method is used in the applying of the liquid material for forming the first transparent thin film F1 and the second transparent thin film F2 in the above embodiment, it is not limited to the above method, and, for example, the other applying method such as a spin coating method, a printing method and a liquid phase method can be used.

While the atmospheric-pressure plasma process is used as a lyophilic treatment in this embodiment, it is not limited to the atmospheric-pressure plasma process, a process of irradiating the substrate P (transparent thin film F) with ultraviolet light with a wavelength of 170 to 400 nm or a process of exposing the substrate P to atmosphere of ozone, for example, can be preferably adopted.

What is claim is:

1. A coloring structure manufacturing apparatus for manufacturing a coloring structure having a prescribed coloring characteristic, comprising:
a film forming device which forms a transparent thin film with a thickness determined according to the coloring characteristic by coating a substrate with a liquid material; and
a reflectance measuring device which measures a reflectance by irradiating the transparent thin film with detection light,
wherein the transparent thin film is formed such that two or more kinds of liquid materials having different refraction indexes are alternately applied to be laminated.

2. The coloring structure manufacturing apparatus according to claim 1,
wherein the reflectance measuring device is configured of a light projector which projects the detection light, a light receiver which receives reflection light reflected by the transparent thin film, and a controller which adjusts the thickness of the transparent thin film at an uppermost layer by controlling the film forming device on the basis of a received result of the light receiver.

3. The coloring structure manufacturing apparatus according to claim 2,
wherein the controller has a memory which stores a relationship between the reflectance and the thickness of the transparent thin film.

4. The coloring structure manufacturing apparatus according to claim 2,
wherein the controller allows the film forming device to apply the liquid material which is selected from the liquid materials having different concentrations prepared by each of the two or more kinds of liquid materials on the basis of a received result of the light receiver.

5. The coloring structure manufacturing apparatus according to claim 1,
wherein the film forming device applies each of the two or more kinds of liquid materials by a droplet discharge method.

6. The coloring structure manufacturing apparatus according to claim 1, further comprising:
a plasma processing device which imparts lyophilicity to the transparent thin film by applying plasma treatment to the transparent thin film, the lyophilicity being with respect to the liquid material to be applied on the transparent thin film.

7. A method for manufacturing a coloring structure having a prescribed coloring characteristic, comprising:
(a) forming a transparent thin film with a thickness determined according to the coloring characteristic by applying a liquid material to a substrate;
(b) laminating the transparent thin films by alternately applying two or more kinds of liquid materials having different refraction indexes to the substrate; and
(c) measuring a reflectance by irradiating the laminated transparent thin film with detection light.

8. The method for manufacturing a coloring structure according to claim 7, further comprising:
(d) adjusting a thickness of the transparent thin film at an uppermost layer on the basis of the measured reflectance.

9. The method for manufacturing a coloring structure according to claim 8, further comprising:
(e) adjusting the thickness of the transparent thin film at the uppermost layer based on a prestored result of a relationship between the reflectance and the thickness of the transparent thin film.

10. The method for manufacturing a coloring structure according to claim 8, further comprising:
(f) applying the liquid material which is selected from the liquid materials having different concentrations prepared by each of the two or more kinds of liquid materials on the basis of the measured reflectance.

11. The method for manufacturing a coloring structure according to claim 7,
wherein applying of each of the two or more kinds of liquid materials may be preferably carried out by using a droplet discharge method.

12. The method for manufacturing a coloring structure according to claim 7, further comprising:
(g) applying plasma treatment to the formed transparent thin film to impart lyophilicity to the transparent thin film, the lyophilicity being with respect to the liquid material to be applied on the transparent thin film.
